(19) United States
(12) Patent Application Publication
(10) Pub. No.: US 2020/0210295 A1
(43) Pub. Date: Jul. 2, 2020

(54) MEMORY SYSTEM AND OPERATING METHOD THEREOF

(71) Applicant: SK hynix Inc., Gyeonggi-do (KR)

(72) Inventors: Joo-Young LEE, Seoul (KR); Chang-Han KIM, Seoul (KR)

(21) Appl. No.: 16/595,121

(22) Filed: Oct. 7, 2019

(30) Foreign Application Priority Data
Dec. 26, 2018 (KR) 10-2018-0169485

(51) Int. Cl. G06F 11/14; G06F 11/10; G06F 11/07

(52) U.S. Cl. CPC G06F 11/1489; G06F 11/1417; G06F 11/1044; G06F 11/1004; G06F 11/076; G06F 11/1458

(57) ABSTRACT

A memory system includes: a memory device including a master block and a back-up master block; and a controller suitable for performing a boot operation by using boot data that is read from the master block or the back-up master block, wherein the controller includes: a booting manager suitable for reading boot data from the back-up master block when an operation of reading the boot data from the master block failed; and a test read manager suitable for performing a test read operation on the back-up master block whenever the number of times that the boot data is read reaches a threshold, and performing a recovery operation on the back-up master block when the test read operation is fails.

### CROSS-REFERENCE TO RELATED APPLICATION

The present application claims priority of Korean Patent Application No. 10-2018-0169485, filed on Dec. 26, 2018, which is incorporated herein by reference in its entirety.

### BACKGROUND

### 1. Field

Various embodiments of the present invention relate to a data processing system, and more particularly, to a memory system for efficiently performing a boot operation, and a method for operating the memory system.

### 2. Description of the Related Art

The computer environment paradigm has shifted to ubiquitous computing, which enables computing systems to be used anytime and anywhere. As a result, use of portable electronic devices such as mobile phones, digital cameras, and laptop computers has rapidly increased. These portable electronic devices generally use a memory system having one or more memory devices for storing data. A memory system may be used as a main memory device or an auxiliary memory device of a portable electronic device.

Memory systems provide excellent stability, durability, high information access speed, and low power consumption since they have no moving parts, as compared with a hard disk device. Examples of memory systems having such advantages include universal serial bus (USB) memory devices, memory cards having various interfaces, and solid state drives (SSDs).

### SUMMARY

Embodiments of the present invention are directed to a memory system that may efficiently perform a boot operation by periodically performing a test read operation on a back-up master block.

In accordance with an embodiment of the present invention, a memory system includes: a memory device including a master block and a back-up master block; and a controller suitable for performing a boot operation by using a boot data that is read from the master block or the back-up master block, wherein the controller includes: a booting manager suitable for reading boot data from the back-up master block when an operation of reading the boot data from the master block failed; and a test read manager unit suitable for performing a test read operation on the back-up master block whenever the number of times that the boot data is read reaches a threshold, and performing a recovery operation on the back-up master block when the test read operation fails.

In accordance with another embodiment of the present invention, a method for operating a memory system includes: performing a boot operation by using boot data that is read from a master block or a back-up master block of a memory device, wherein the performing of the boot operation includes: reading boot data from the back-up master block when an operation of reading the boot data from a master block failed; and performing a test read operation on the back-up master block whenever the number of times that the boot data is read reaches a threshold; and performing a recovery operation on the back-up master block when the test read operation fails.

In accordance with another embodiment of the present invention, a memory system includes: a memory device including a master block and a back-up block for storing boot data; and a controller suitable for: reading the boot data from the master block; performing a boot operation by using the read boot data; and after performing the boot operation, periodically performing a test read operation of reading the boot data from the back-up block.

The controller may be further suitable for performing a recovery operation on the back-up block when the test read operation fails.

### BRIEF DESCRIPTION OF THE DRAWINGS

FIG. 1 is a block diagram illustrating a data processing system including a memory system in accordance with an embodiment of the present invention.

FIG. 2 is a schematic diagram illustrating an exemplary configuration of a memory device employed in the memory system shown in FIG. 1.

FIG. 3 is a circuit diagram illustrating an exemplary configuration of a memory cell array of a memory block in the memory device shown in FIG. 1.

FIG. 4 is a block diagram illustrating a structure of a memory device of a memory system in accordance with an embodiment of the present invention.

FIG. 5 is a diagram showing a threshold voltage distribution schematically illustrating program and erase states of a 3-bit multi-level cell (3-bit MLC) non-volatile memory device.

FIG. 6 is a diagram showing a threshold voltage distribution schematically illustrating program and erase states due to characteristic deterioration of a 3-bit MLC non-volatile memory device.

FIG. 7 is a flowchart illustrating a conventional boot data read operation.

FIG. 8 is a flowchart illustrating an operation of a memory system in accordance with an embodiment of the present invention.

FIG. 9 is a block diagram illustrating a data processing system in accordance with an embodiment of the present invention.

FIG. 10 is a block diagram illustrating a recovery operation in accordance with an embodiment of the present invention.

FIGS. 11 to 19 are diagrams schematically illustrating exemplary applications of the data processing system in accordance with various embodiments of the present invention.

### DETAILED DESCRIPTION

Various embodiments of the present invention are described below in more detail with reference to the accompanying drawings. The present invention may, however, be embodied in different forms and should not be construed as limited to the embodiments set forth herein. Rather, these embodiments are provided so that this disclosure is thorough and complete and fully conveys the scope of the present invention to those skilled in the art. Throughout the disclosure, like reference numerals refer to like parts throughout the various figures and embodiments of the present invention.

It is noted that reference to “an embodiment,” “another embodiment” or the like does not necessarily mean only one embodiment, and different references to any such phrase are not necessarily to the same embodiment(s).

It will be understood that, although the terms “first” and/or “second” may be used herein to identify various elements, these elements are not limited by these terms. These terms are only used to distinguish one element from another element. A first element in one instance could be termed a second element in another instance, and vice versa, without departing from the teachings of the present disclosure.

It will be understood that when an element is referred to as being “coupled” or “connected” to another element, it can be directly coupled or connected to the other element or one or more intervening elements may be present therebetween. In contrast, it should be understood that when an element is referred to as being “directly coupled” or “directly connected” to another element, there are no intervening elements present. Other expressions that explain the relationship between elements, such as “between”, “directly between”, “adjacent to” or “directly adjacent to” should be construed in the same way.

The terminology used herein is for the purpose of describing particular embodiments only and is not intended to be limiting. In the present disclosure, the singular forms are intended to include the plural forms and vice versa, unless the context clearly indicates otherwise. It will be further understood that the open-ended terms “comprise”, “include”, “have”, etc. when used in this specification, specify the presence of stated features, numbers, steps, operations, elements, components, and/or combinations thereof but do not preclude the presence or addition of one or more other features, numbers, steps, operations, elements, components, and/or combinations thereof.

The embodiments described herein are merely for the purpose of understanding the technical spirit of the present disclosure; the scope of the present invention is not limited to the disclosed embodiments. It will be apparent to those skilled in the art to which the present disclosure pertains, in light of the present disclosure, that various modifications based on the technical spirit of the present disclosure may be made to any of the disclosed embodiments.

Unless otherwise defined, all terms including technical and scientific terms used herein have the same meaning as commonly understood by one of ordinary skill in the art to which the present disclosure pertains. Unless otherwise defined in the present disclosure, the terms should not be construed in an ideal or excessively formal way.

Various embodiments of the present invention are described in detail below with reference to the attached drawings.

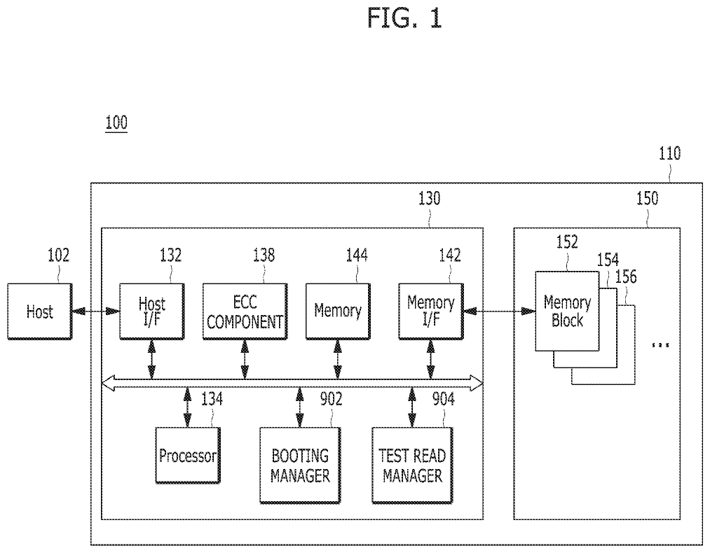

FIG. 1 is a block diagram illustrating a data processing system 100 including a memory system 110 in accordance with an embodiment of the present invention.

Referring to FIG. 1, the data processing system 100 may include a host 102 and the memory system 110.

The host 102 may include any of a variety of portable electronic devices such as a mobile phone, a MP3 player and a laptop computer, or any of a variety of non-portable electronic devices such as a desktop computer, a game machine, a television (TV) and a projector.

The host 102 may include at least one operating system (OS) or a plurality of operating systems. The host 102 may execute an OS to perform an operation corresponding to a user's request on the memory system 110. Here, the host 102 may provide a plurality of commands corresponding to a user's request to the memory system 110. Thus, the memory system 110 may perform certain operations corresponding to the plurality of commands, that is, corresponding to the user's request. The OS may manage and control overall functions and operations of the host 102. The OS may support an operation between the host 102 and a user using the data processing system 100 or the memory system 110.

The memory system 110 may operate or perform a specific function or operation in response to a request from the host 102. Particularly, the memory system 110 may store data to be accessed by the host 102. The memory system 110 may be used as a main memory system or an auxiliary memory system of the host 102. The is memory system 110 may be implemented with any of various types of storage devices, which may be electrically coupled with the host 102, according to a protocol of a host interface. Non-limiting examples of the memory system 110 include a solid state drive (SSD), a multi-media card (MMC) and an embedded MMC (eMMC).

The memory system 110 may include various types of storage devices. Non-limiting examples of such storage devices include volatile memory devices such as a dynamic random access memory (DRAM) and a static RAM (SRAM) and nonvolatile memory devices such as a read only memory (ROM), a mask ROM (MROM), a programmable ROM (PROM), an erasable programmable ROM (EPROM), an electrically erasable programmable ROM (EEPROM), a ferroelectric RAM (FRAM), a phase-change RAM (PRAM), a magneto-resistive RAM (MRAM), a resistive RAM (RRAM), and a flash memory.

The memory system 110 may include a controller 130 and a memory device 150.

The controller 130 and the memory device 150 may be integrated into a single semiconductor device, which may be included in any of the various types of memory systems as described above. For example, the controller 130 and the memory device 150 may be integrated as a single semiconductor device to constitute a solid state drive (SSD), a personal computer memory card international association (PCMCIA) card, a secure digital (SD) card (e.g., a mini-SD, a micro-SD and an SD High Capacity (SDHC)), and/or an universal flash storage (UFS) device. The memory system 110 may be configured as a part of a computer, a smart phone, a portable game player, or any of various components configuring a computing system.

The memory device 150 may be a nonvolatile memory device which may retain stored data even though power is not supplied. The memory device 150 may store data provided from the host 102 through a write operation, and output data stored therein to the host 102 through a read operation. In an embodiment, the memory device 150 may include a plurality of memory dies (not shown), and each memory die may include a plurality of planes (not shown). Each plane may include a plurality of memory blocks 152 to 156, each of which may include a plurality of pages, each of which may include a plurality of memory cells coupled to a word line. In an embodiment, the memory device 150 may be a flash memory having a 3-dimensional (3D) stack structure.

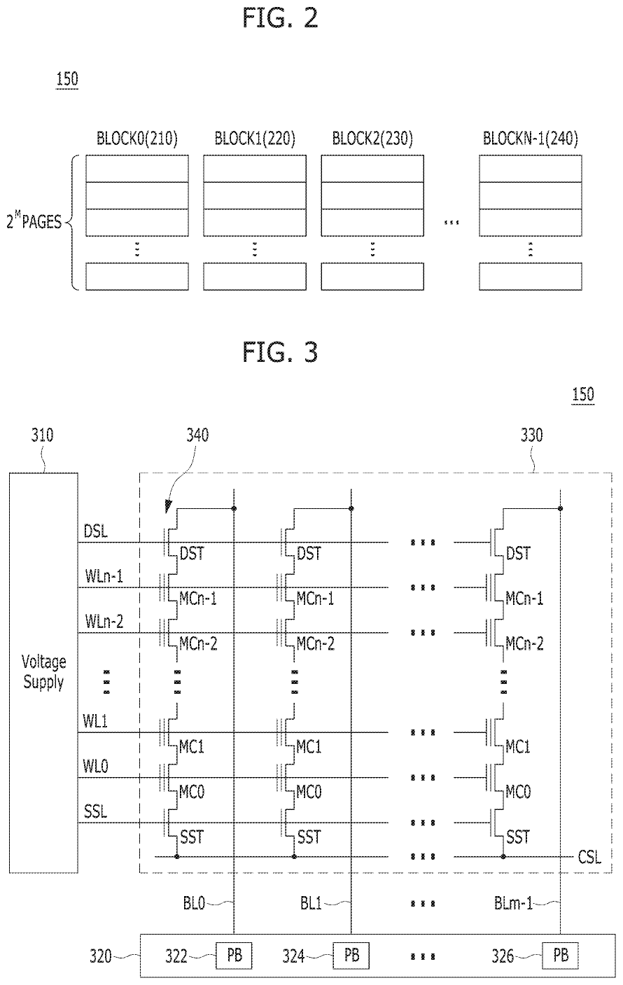

The structure of the memory device 150 and the 3D stack structure of the memory device 150 is described in detail below with reference to FIGS. 2 to 4.

The controller 130 may control the memory device 150 in response to a request from the host 102. For example, the controller 130 may provide data read from the memory device 150 to the host 102, and store data provided from the host 102 into the memory device 150. For this operation, the controller 130 may control read, write, program and erase operations of the memory device 150.

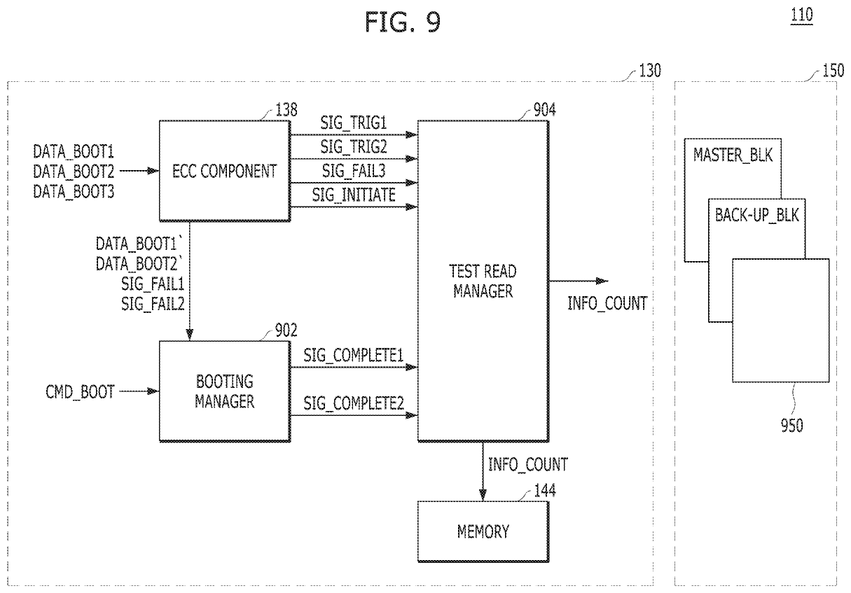

More specifically, the controller 130 may include a host interface (I/F) 132, a processor 134, an error correction code (ECC) component 138, a memory interface 142, and a memory 144, all operatively coupled or engaged via an internal bus. As to be described below with reference to FIG. 9, the controller 130 may further include a booting manager 902 and a test read manager 904.

The host interface 132 may process a command and data of the host 102. The host interface 132 may communicate with the host 102 through one or more of various interface protocols, such as universal serial bus (USB), multi-media card (MMC), peripheral component interconnect-express (PCI-e or PCIe), small computer system interface (SCSI), serial-attached SCSI (SAS), serial advanced technology attachment (SATA), parallel advanced technology attachment (DATA), enhanced small disk interface (ESDI) and integrated drive electronics (IDE). The host interface 132 may be driven via firmware, that is, a host interface layer (HIL) for exchanging data with the host 102.

The ECC component 138 may correct error bits of data to be processed by the memory device 150 and may include an ECC encoder and an ECC decoder. The ECC encoder may perform an error correction encoding on data to be programmed into the memory device 150 to generate data to which a parity bit is added. The data including the parity bit may be stored in the memory device 150. The ECC decoder may detect and correct an error contained in the data read from the memory device 150. The ECC component 138 may perform error correction through a coded modulation such as a Low Density Parity Check (LDDC) code, a Bose-Chaudhri-Hocquenghem (BCH) code, a turbo code, a Reed-Solomon (RS) code, a convolution code, a Recursive Systematic Code (RSC), a Trellis-Coded Modulation (TCM) and a Block coded modulation (BCM). However, the ECC component 138 is not limited to these error correction techniques. As such, the ECC component 138 may include any and all circuits, modules, systems or devices for performing suitable error correction.

The memory interface 142 may serve as a memory/storage interface between the controller 130 and the memory device 150 such that the controller 130 may control the memory device 150 in response to a request from the host 102.

The memory 144 may serve as a working memory of the memory system 110 and the controller 130, and store data for driving the memory system 110 and the controller 130.

The memory 144 may be a volatile memory. For example, the memory 144 may be a static random access memory (SRAM) or dynamic random access memory (DRAM). The memory 144 may be disposed within or external to the controller 130. In an embodiment, as shown in FIG. 1, the memory 144 may be disposed within the controller 130. In another embodiment, the memory 144 may be an external volatile memory having a memory interface for transferring data between the memory 144 and the controller 130.

As described above, the memory 144 may include a program memory, a data memory, a write buffer/cache, a read buffer/cache, a data buffer/cache and a map buffer/cache to store some data required to perform data write and read operations between the host 102 and the memory device 150 and other data required for the controller 130 and the memory device 150 to perform these operations.

The processor 134 may control overall operations of the memory system 110. The processor 134 may use firmware to control the overall operations of the memory system 110. The firmware may be referred to as flash translation layer (FTL). The processor 134 may be implemented with a microprocessor or a central processing unit (CPU).

For example, the controller 130 may perform an operation requested by the host 102 in the memory device 150 through the processor 134. Also, the controller 130 may perform a background operation on the memory device 150 through the processor 134. The background operation may include an operation of copying and processing data stored in some memory blocks among the memory blocks 152 to 156 of the memory device 150 into other memory blocks (i.e., a garbage collection (GC) operation), an operation of swapping data between select memory blocks of the memory blocks 152 to 156 (i.e., a wear-leveling (WL) operation), an operation of storing the map data stored in the controller 130 in the memory blocks 152 to 156 (i.e., a map flush operation), or an operation of managing bad blocks of the memory device 150 (i.e., a bad block management operation of detecting and processing bad blocks among the memory blocks 152 to 156 in the memory device 150).

The memory device of the memory system in accordance with an embodiment of the present invention is described in detail with reference to FIGS. 2 to 4.

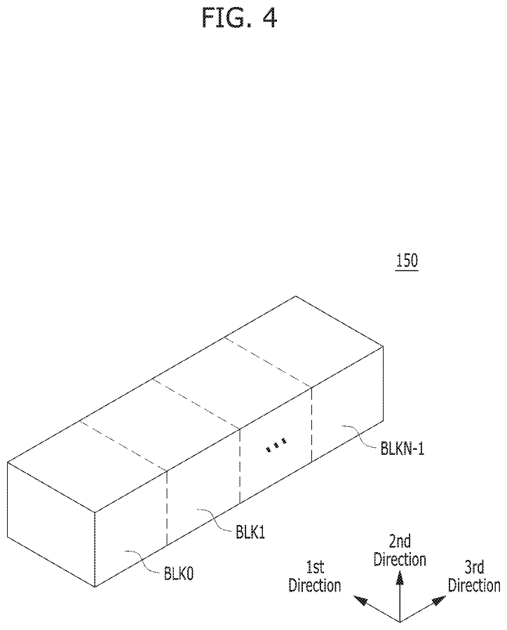

FIG. 2 is a schematic diagram illustrating the memory device 150. FIG. 3 is a diagram illustrating an exemplary configuration of a memory cell array of a memory block 330 in the memory device 150. FIG. 4 is a diagram illustrating an exemplary three-dimensional (3D) structure of the memory device 150.

Referring to FIG. 2, the memory device 150 may include a plurality of memory blocks BLOCK0 to BLOCKN-1, where N is an integer greater than 1. Each of the blocks BLOCK0 to BLOCKN-1 may include a plurality of pages, for example, 2^{M} or M pages, the number of which may vary according to circuit design, M being an integer greater than 1. Each of the pages may include a plurality of memory cells that are coupled to a plurality of word lines WL.

Memory cells in the respective memory blocks BLOCK0 to BLOCKN-1 may be one or more of a single level cell (SLC) storing 1-bit data or a multi-level cell (MLC) storing 2-bit data. Hence, the memory device 150 may include memory blocks including SLCs (i.e., SLC memory blocks) or memory blocks including MLCs (i.e., MLC is memory blocks), depending on the number of bits which can be expressed or stored in each of the memory cells in the memory blocks. The SLC memory blocks may include a plurality of pages which are embodied by memory cells, each storing one-bit data. The SLC memory blocks may generally have higher data computing performance and higher durability than the MLC memory blocks. The MLC memory blocks may include a plurality of pages which are embodied by memory cells each storing multi-bit data (for example, 2 or more bits). The MLC memory blocks may generally have larger data storage space, that is, higher integration density, than the SLC memory blocks. In another embodiment, the memory device 150 may include a plurality of triple level cell (TLC) memory blocks. The TCL memory blocks may include a plurality of pages which are embodied by memory cells each capable of storing 3-bit data. In yet another embodiment, the memory device 150 may include a plurality of quadruple level cell (QLC) memory blocks. The QLC memory blocks may include a plurality of pages which are embodied by memory cells each capable of storing 4-bit data.

Instead of a nonvolatile memory, the memory device 150 may be implemented by any of a phase change random access memory (PCRAM), a resistive random access memory (RRAM or ReRAM), a ferroelectrics random access memory (FRAM), and a spin transfer torque magnetic random access memory (STT-RAM or STT-MRAM).

The memory blocks 210, 220, 230, 240 may store the data transferred from the host 102 through a program operation, and may transfer data stored therein to the host 102 through a read operation.

Referring to FIG. 3, a memory block 330, representative of any of the memory blocks of the memory device 150, may include a plurality of cell strings 340 coupled to a plurality of corresponding bit lines BL0 to BLm-1. The cell string 340 of each column may include one or more drain select transistors DST and one or more source select transistors SST. Between the drain and source select transistors DST and SST, a plurality of memory cells MC0 to MCn-1 may be coupled in series. In an embodiment, each of the memory cell transistors MC0 to MCn-1 may be embodied by an MLC capable of storing data information of a plurality of bits. Each of the cell strings 340 may be electrically coupled to a corresponding bit line among the plurality of bit lines BL0 to BLm-1. For example, as illustrated in FIG. 3, the first cell string is coupled to the first bit line BL0, and the last cell string is coupled to the last bit line BLm-1.

Although FIG. 3 illustrates NAND flash memory cells, the present invention is not limited thereto. It is noted that the memory cells may be NOR flash memory cells, or hybrid flash memory cells including two or more kinds of memory cells combined therein. Also, it is noted that the memory device 150 may be a flash memory device including a conductive floating gate as a charge storage layer or a charge trap flash (CTF) memory device including an insulation layer as a charge storage layer.

The memory device 150 may further include a voltage supply 310 which generates different word line voltages including a program voltage, a read voltage, and a pass voltage to supply to the word lines according to an operation mode. The voltage generation operation of the voltage supply 310 may be controlled by a control circuit (not illustrated). Under the control of the control circuit, the voltage supply 310 may select at least one of the memory blocks (or sectors) of the memory cell array, select at least one of the word lines of the selected memory block, and provide the word line voltages to the selected word line(s) and the unselected word lines as may be needed.

The memory device 150 may include a read/write circuit 320 which is controlled by the control circuit. During a verification/normal read operation, the read/write circuit 320 may operate as a sense amplifier for reading (sensing and amplifying) data from the memory cell array. During a program operation, the read/write circuit 320 may operate as a write driver for supplying a voltage or a current to bit lines according to data to be stored in the memory cell array. During a program operation, the read/write circuit 320 may receive data to be stored into the memory cell array from a buffer (not illustrated), and drive bit lines according to the received data. The read/write circuit 320 may include a plurality of page buffers 322 to 326 respectively corresponding to columns (or bit lines) or column pairs (or bit line pairs). Each of the page buffers 322 to 326 may include a plurality of latches (not illustrated).

The memory device 150 may be embodied by a two-dimensional (2D) or three-dimensional (3D) memory device. Particularly, as illustrated in FIG. 4, the memory device 150 may be embodied by a nonvolatile memory device having a 3D stack structure. When the memory device 150 has a 3D structure, the memory device 150 may include a plurality of memory blocks BLK0 to BLKN-1. Herein, FIG. 4 is a block diagram illustrating the memory blocks 152, 154 and 156 of the memory device 150 shown in FIG. 1. Each of the memory blocks 152, 154 and 156 may be realized in a 3D structure (or vertical structure). For example, each of the memory blocks 152, 154 and 156 may be a 3D structure with dimensions extending in first to third directions, e.g., an x-axis direction, a y-axis direction, and a z-axis direction.

Each memory block 330 in the memory device 150 may include a plurality of NAND strings NS that extend in the second direction. A plurality of NAND strings NS extend in the first direction and the third direction. Herein, each of the NAND strings NS may be coupled to a bit line BL, at least one string select line SSL, at least one ground select line GSL, a plurality of word lines WL, at least one dummy word line DWL, and a common source line CSL, and each of the NAND strings NS may include a plurality of transistor structures TS.

In short, each memory block 330, among the memory blocks 152, 154 and 156 of the memory device 150, may be coupled to a plurality of bit lines BL, a plurality of string select lines SSL, a plurality of ground select lines GSL, a plurality of word lines WL, a plurality of dummy word lines DWL, and a plurality of common source lines CSL, and each memory block 330 may include a plurality of NAND strings NS. In each memory block 330, one bit line BL may be coupled to a plurality of NAND strings NS to realize a plurality of transistors in one NAND string NS. A string select transistor SST of each NAND string NS may be coupled to a corresponding bit line BL, and a ground select transistor GST of each NAND string NS may be coupled to a common source line CSL. Herein, memory cells MC may be provided between the string select transistor SST and the ground select transistor GST of each NAND string NS. In other words, a plurality of memory cells may be realized in each memory block 330 of the memory blocks 152, 154 and 156 of the memory device 150.

As described above with reference to FIG. 2, the flash memory may determine a state of data which can be stored in each of the memory cells, according to the number of bits stored in each of the memory cells. A memory cell storing 1-bit data per cell is called a single-bit cell or a single-level cell (SLC). A memory cell storing multi-bit data (i.e., 2 or more bits data) per cell is called a multi-bit cell, a multi-level cell (MLC) or a multi-state cell. The MLC is advantageous for high integration. However, as the number of bits programmed in each memory cell increase, the reliability decreases and the read failure rate increases.

For example, when k bits are to be programmed in a memory cell, one of 2^{k} threshold voltages is formed in the memory cell. Due to the minute differences between the electrical characteristics of memory cells, the threshold voltages of memory cells programmed for the same data form threshold voltage distribution. The threshold voltage distributions correspond to 2^{k} data values representing k-bit information, respectively.

However, a voltage window available for the threshold voltage distributions is finite. Therefore, as the value k increases, the distance between the threshold voltage distributions decreases and the neighboring threshold voltage distributions overlap each other. As the neighboring threshold voltage distributions overlap each other, read data may include several or several tens of error bits.

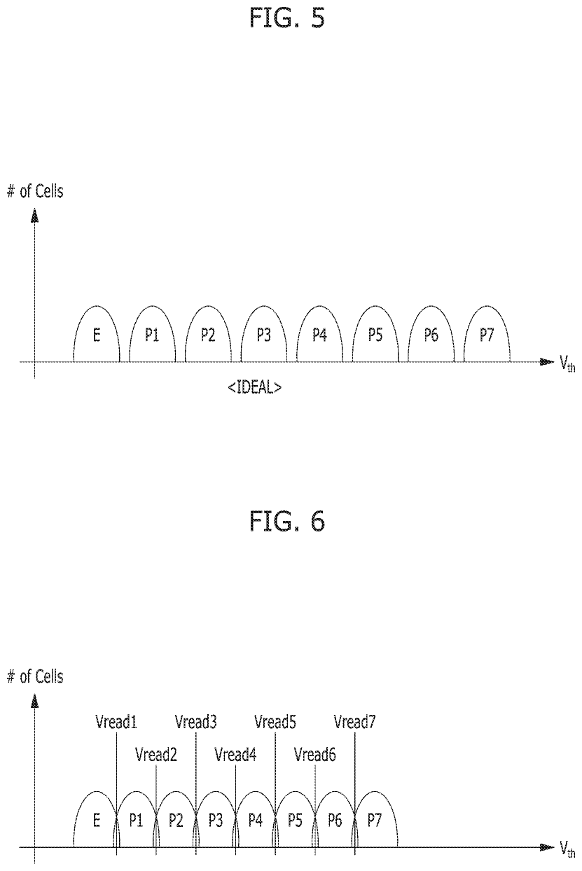

FIG. 5 is a threshold voltage distribution schematically illustrating program and erase states of a 3-bit MLC non-volatile memory device.

FIG. 6 is a threshold voltage distribution schematically illustrating program and erase states due to characteristic deterioration of the 3-bit MLC non-volatile memory device.

In the MLC non-volatile memory device, e.g., the MLC flash memory device capable of storing k-bit data in a single memory cell, the memory cell may have one of 2^{k} threshold voltage distributions. For example, the 3-bit MLC has one of 8 threshold voltage distributions.

The threshold voltages of memory cells programmed for the same data form the threshold voltage distribution due to characteristic differences between memory cells. In the 3-bit MLC non-volatile memory device, as illustrated in FIG. 5, the threshold voltage distributions are formed in correspondence with the data states including 7 program states ‘P1’ to ‘P7’ and an erase state ‘E’. FIG. 5 shows an ideal case in which the threshold voltage distributions do not overlap and have read voltage margins therebetween.

Referring to FIG. 6, the memory cell may experience charge loss that electrons trapped at a floating gate or tunnel oxide film are discharged over time. Such charge loss may accelerate when the tunnel oxide film deteriorates by iterative program and erase operations. The charge loss results in a decrease in the threshold voltages of memory cells. For example, as illustrated in FIG. 6, the threshold voltage distribution may be shifted left due to charge loss.

Further, program disturbance, erase disturbance and/or back pattern dependency cause increases in threshold voltages. As characteristics of memory cells deteriorate, neighbouring threshold voltage distributions may overlap, as illustrated in FIG. 6.

Once neighbouring threshold voltage distributions overlap, read data may include a significant number of errors when a particular read voltage is applied to a selected word line. For example, when a sensed state of a memory cell according to a read voltage Vread3 applied to a selected word line is on, the memory cell is determined to have a second program state ‘P2’. When a sensed state of a memory cell according to a read voltage Vread3 applied to a selected word line is off, the memory cell is determined to have a third program state ‘P3’. However, when neighbouring threshold voltage distributions overlap, the memory cell actually having the third program state ‘P3’ may be erroneously determined to have the second program state ‘P2’.

A master block MASTER_BLK may store a boot loader and firmware (FW) that are used for a boot operation, collectively referred to as boot data. When a boot command CMD_BOOT is provided from the host 102, the controller 130 may control the memory device 150 to read the boot data from the master block. The controller 130 may perform a boot operation by using the read boot data.

When the master block is deteriorated due to a charge loss or a program disturbance phenomenon described earlier with reference to FIG. 6, the boot data that is read by the memory device 150 from the master block may include an un-correctable error correction code (UECC) error. When the boot data that is read from the master block includes an UECC error, the controller 130 may process a read operation performed on the boot data (i.e., a boot data read operation) as a failure. When the boot data read operation fails, the controller 130 may not perform a boot operation using the read boot data.

The controller 130 may control the memory device 150 to store a back-up data for the master block to cope with a case where the master block is so deteriorated that a boot operation is not performed. The controller 130 may control the memory device 150 to perform a back-up operation of copying the boot data stored in the master block into a back-up master block. Therefore, when the boot data read operation on the master block fails, the controller 130 may control the memory device 150 to read the boot data from the back-up master block.

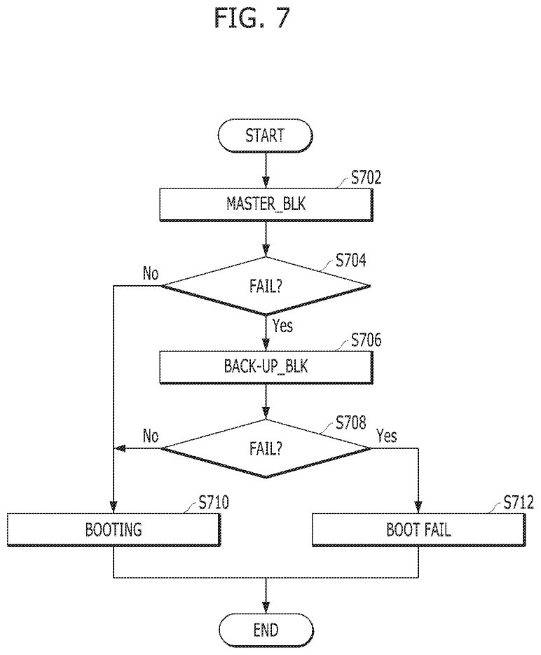

FIG. 7 is a flowchart illustrating a conventional boot data read operation.

Referring to FIG. 7, in step S702, the controller 130 of FIG. 1 may control the memory device 150 to read boot data stored in a master block MASTER_BLK in response to a boot command CMD_BOOT provided from the host 102. The boot data may collectively refer to data necessary for performing a boot operation, and may include a boot loader and firmware. The memory device 150 may provide the controller 130 with the boot data that is read from the master block.

In step S704, the controller 130 may detect and correct an error in the boot data that is provided in step S702. When the error in the boot data is corrected, the controller 130 may process the boot data read operation as having passed. When the controller 130 has processed the boot data read operation as having passed (‘No’ in step S704), the controller 130 may perform a boot operation using the corrected boot data in step S710.

When the controller 130 processes the boot data read operation as a failure (‘Yes’ in step S704), in step S706, the controller 130 may control the memory device 150 to read the boot data that is stored in the back-up master block BACK-UP_BLK. When the controller 130 does not correct the error in the boot data, the controller 130 may process the boot data read operation as a failure. For example, when the number of error bits that are included in the boot data is greater than or equal to a threshold, which may be predetermined, or when the error in the boot data is an UECC error, the controller 130 may process the boot data read operation as a failure. The memory device 150 may provide the controller 130 with the boot data that is read from the back-up master block.

In step S708, the controller 130 may detect and correct the error in the boot data that is provided in step S706. When the error in the boot data is corrected, the controller 130 may process the boot data read operation as having passed. When the controller 130 processes the boot data read operation as having passed (‘No’ in step S708), the boot operation may be performed using the corrected boot data in step S710. When the controller 130 processes the boot data read operation as a failure (‘Yes’ in step S708), the controller 130 may process the boot operation as a failure in step S712.

According to the conventional boot data read operation, only when a read operation on the master block fails in the middle of is repeatedly performing a boot operation by reading the boot data from the master block whenever a boot command CMD_BOOT is provided, the controller 130 may read the boot data stored in the back-up master block. Since the controller 130 does not perform a read operation on the back-up master block while performing the read operation on the master block, the back-up master block may not be deteriorated by the program disturbance, which is described earlier with reference to FIG. 6, but it may be deteriorated by the charge loss. When the back-up master block is deteriorated due to the charge loss or the like, the back-up master block at the moment of performing a read operation for the back-up master block after the read operation for the master block has failed is already deteriorated, the read operation for the back-up master block may be failed.

As described above, the controller 130 may not perform a read operation for the back-up master block unless the read operation for the master block fails. Therefore, there may be a concern in that the integrity of the back-up master block is not ensured at the moment when the read operation for the master block fails and thus the back-up master block is read. Since a failure of a boot operation is fatal, the controller 130 may generate a back-up master block to cope with a case where a read operation on the master block failed. However, when the integrity of the back-up master block is not ensured at the moment when the back-up master block is to be read, the boot operation may be highly likely to be failed.

According to an embodiment of the present invention, the controller 130 may control the memory device 150 to perform a test read operation of periodically performing a read operation on the back-up master block. Thus, the read operation is not performed on the back-up master block only when the read operation on the master block has failed. When it is determined that the back-up master block is deteriorated as a result of the test read operation, the controller 130 may perform a recovery operation on the back-up master block. Therefore, according to an embodiment of the present invention, when the back-up master block is deteriorated as a result of periodically performing the test read operation, the controller 130 may ensure the integrity of the back-up master block for use whenever a read operation is to be performed on the back-up master block after a read operation performed on a master block is processed as a failure by performing a recovery operation on the back-up master block.

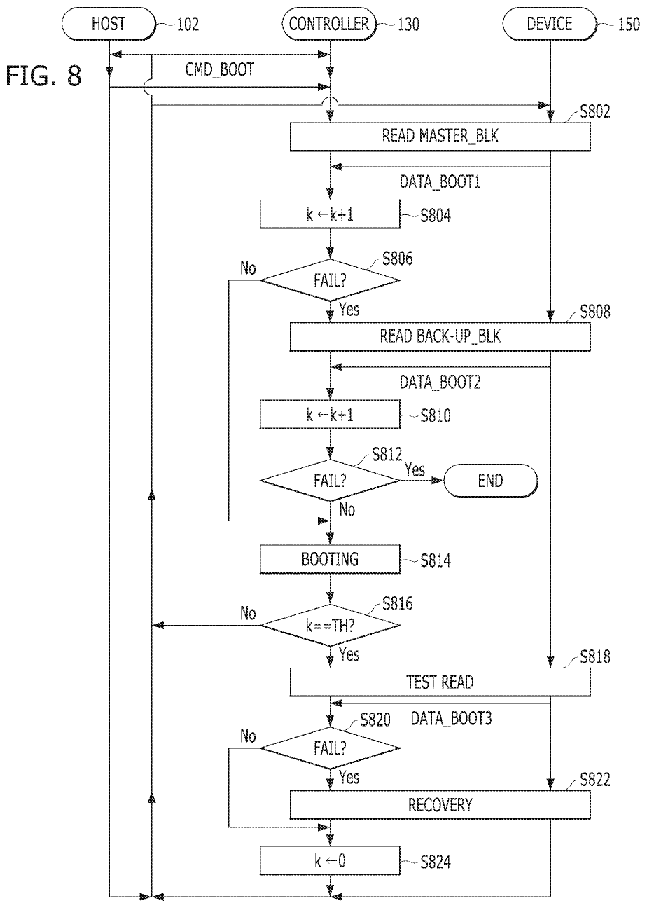

FIG. 8 is a flowchart illustrating an operation of the memory system 110 in accordance with an embodiment of the present invention.

Referring to FIG. 8, in step S802, the controller 130 may control the memory device 150 to read boot data stored in a master block MASTER_BLK in response to a boot command CMD_BOOT provided from the host 102. For example, the user may provide the controller 130 with the boot command CMD_BOOT by pressing a boot button. The boot data may collectively refer to data that are necessary for the controller 130 to perform a boot operation, and may include a boot loader and firmware. The memory device 150 may provide the controller 130 with first boot data DATA_BOOT1 that is read from the master block MASTER_BLK.

In step S804, the controller 130 may increment a count value k when it reads the boot data in step S802. According to an embodiment of the present invention, the controller 130 may increment the count value k whenever the memory device 150 reads the boot data to keep a cumulative count of such reads. Further, when the count value k reaches a threshold value TH (‘Yes’ in step S816), in step S818, the controller 130 may control the memory device 150 to perform a test read operation on a back-up master block BACK-UP BLK. The controller 130 may store information about the count value in the memory 144 and may control the memory device 150 to program the information about the count value in a memory block to cope with sudden power-off (SPO).

Following the reading of boot data in master block MASTER_BLK (step S802) and incrementing k (step S804), in step S806 the controller 130 may detect and correct an error in the first boot data DATA_BOOT1 provided in step S802. When the error in the first boot data DATA_BOOT1 is corrected, the controller 130 may process the boot data read operation as having passed. When the controller 130 processes the boot data read operation as having passed (‘No’ in step S806), the controller 130 may perform a boot operation by using the corrected boot data in step S814.

When the controller 130 processes the boot data read operation as a failure (‘Yes’ in step S806), in step S808, the controller 130 may control the memory device 150 to read the boot data stored in the back-up master block BACK-UP_BLK. When the error in the boot data is not corrected, the controller 130 may process the boot data read operation as a failure. According to an embodiment of the present invention, when the number of error bits in the boot data is greater than or equal to a threshold value or the error in the boot data is an uncorrectable error (Le., a UECC error), the controller 130 may process the boot data read operation as a failure. The memory device 150 may provide the controller 130 with second boot data DATA_BOOT2 that is read from the back-up master block BACK-UP_BLK.

In step S810, the controller 130 may increment the count value k when it reads the boot data in step S808. According to an embodiment of the present invention, the controller 130 may increment the count value k whenever the memory device 150 reads the boot data as described above. Therefore, the count value k may be incremented not only when the boot data is read from the master block MASTER_BLK in step S802 but also when the data is read from the back-up master block BACK-UP_BLK in step S808.

In step S812, the controller 130 may detect and correct an error in the second boot data DATA_BOOT2 provided in step S808. The controller 130 may process the boot data read operation as having passed when the error in the second boot data DATA_BOOT2 is corrected. When the controller 130 processes the boot data read operation as having passed (‘No’ in step S812), the boot operation may be performed using the corrected boot data in step S814. When the controller 130 processes the boot data read operation as a failure (‘Yes’ in step S812), the controller 130 may process a boot operation as a failure.

According to an embodiment of the present invention, the controller 130 may perform a test read operation and a recovery operation on the back-up master block BACK-UP_BLK, whenever the count value k reaches the threshold value TH, which will be described later. Since the integrity of the back-up master block BACK-UP_BLK may be ensured when a boot data read operation is performed on the back-up master block BACK-UP_BLK in step S808, the boot data read operation may be less likely to be processed as a failure in step S812.

In step S814, when the boot data is successfully read as described above (‘No’ in step S806 or ‘No’ in step S812), the controller 130 may perform a boot operation. According to an embodiment of the present invention, the controller 130 may periodically perform a test read operation on the back-up master block BACK-UP_BLK, which will be described later. In this way, the number of error bits in the second boot data DATA_BOOT2 that is read in step S808 may be reduced. Consequently, the error in the second boot data DATA_BOOT2 may be corrected in step S812 with a relatively higher probability.

In step S816, the controller 130 may compare the count value k with the threshold value TH. According to an embodiment of the present invention, when the count value k has not reached the threshold TH (‘No’ in step S816), the controller 130 may go back to step S802 to repeat the operations of steps S802 to S814 in response to a boot command CMD_BOOT provided from the host 102.

In step S818, when the count value k reaches the threshold TH (‘Yes’ in step S816), the controller 130 may control the memory device 150 to perform a test read operation 1.50. The controller 130 may control the memory device 150 to perform the test read operation of reading the boot data stored in the back-up master block BACK-UP_BLK. The memory device 150 may provide the controller 130 with third boot data DATA_BOOT3 that is read from the back-up master block BACK-UP_BLK according to the test read operation.

In step S820, the controller 130 may detect and correct an error in the third boot data DATA_BOOT3 provided in step S818. When the error in the third boot data DATA_BOOT3 is corrected (‘No’ in step S820), the controller 130 may initialize the counter value k to ‘0’ in step S824, and then go back to step S802 to repeat the operations of steps S802 to S822.

In step S822, when the controller 130 fails to correct the error in the third boot data DATA_BOOT3 and processes the boot data read operation as a failure (‘Yes’ in step S820), the controller 130 may control the memory device 150 to perform a recovery operation on the back-up master block BACK-UP_BLK. The controller 130 may generate a new block for storing the boot data DATA_BOOT in addition to the master block MASTER_BLK according to the recovery operation and uses the new block as a back-up block for the master block MASTER_BLK, and processes the deteriorated back-up master block BACK-UP_BLK as a bad block. For example, the controller 130 may allocate a new block and control the memory device 150 to copy the boot data BOOT_DATA included in the master block MASTER_BLK into the allocated block. The allocated new block may be a block that is not deteriorated by charge loss or program disturbance. According to an embodiment of the present invention, the controller 130 may reduce the number of error bits included in the second boot data DATA_BOOT2 that is read from the back-up master block BACK-UP_BLK in step S812 by using the allocated new block as a back-up master block BACK-UP_BLK.

In step S824, the controller 130 may initialize the counter value k to ‘0’, and then go back to step S802 to repeat the operations of steps S802 to S822. The controller 130 may initialize the counter value k after performing a test read operation, and thereby control the memory device 150 to perform a test read operation on the back-up master block BACK-UP_BLK whenever the counter value k, which is is incremented whenever the boot data is read in response to the boot command CMD_BOOT, reaches the threshold value TH.

FIG. 9 is a block diagram illustrating a data processing system 100 in accordance with an embodiment of the present invention. For example, FIG. 9 schematically shows only the constituent elements related to the present invention in the data processing system 100 of FIG. 1.

Referring to FIG. 9, the controller 130 of FIG. 1 may further include a booting manager 902 and a test read manager 904. The memory device 150 may include a master block MASTER_BLK and a back-up master block BACK-UP_BLK.

The booting manager 902 may control the memory device 150 to read the boot data that is stored in the master block MASTER_BLK in response to a boot command CMD_BOOT provided from the host 102. The memory device 150 may provide the ECC component 138 with the first boot data DATA_BOOT1 that is read from the master block. The ECC component 138 may provide the test read manager 904 with a first trigger signal SIG_TRIG1 whenever the memory device 150 reads the first boot data DATA_BOOT1 from the master block MASTER_BLK.

The test read manager 904 may increment the count value k in response to the provided first trigger signal SIG_TRIG1. According to an embodiment of the present invention, the test read manager 904 may increment the count value k whenever the memory device 150 reads the boot data by incrementing the count value k whenever the first trigger signal SIG_TRIG1 from the ECC component 138 is received. The test read manager 904 may store the information INFO_COUNT about the count value in the memory 144, and may control the memory device 150 to program the information INFO_COUNT about the count value in a memory block 950 to cope with sudden power-off (SPO).

The ECC component 138 may detect and correct an error in the first boot data DATA_BOOT1. When the error in the first boot data DATA_BOOT1 is corrected, the ECC component 138 may process the boot data read operation on the master block MASTER_BLK as having passed. When the ECC component 138 processes the boot data read operation on the master block MASTER_BLK as having passed, the ECC component 138 may provide the booting manager 902 with the corrected first boot data DATA_BOOT1′. When the error in the first boot data DATA_BOOT1 is not corrected, the ECC component 138 may process the boot data read operation on the master block MASTER_BLK as a failure. When the boot data read operation on the master block MASTER_BLK is processed as a failure, the ECC component 138 may provide the booting manager 902 with a first failure signal SIG_FAIL1.

The booting manager 902 may perform a boot operation using the first boot data DATA_BOOT1. The booting manager 902 may provide the test read manager 904 with a first completion signal SIG_COMPLETE1 after completing the boot operation. Also, the booting manager 902 may control the memory device 150 to read the boot data stored in the back-up master block BACK-UP_BLK in response to the first failure signal SIG_FAIL1 provided from the ECC component 138. The memory device 150 may provide the ECC component 138 with the second boot data DATA_BOOT2 that is read from the back-up master block BACK-UP_BLK. Whenever the memory device 150 reads the second boot data DATA_BOOT2 from the back-up master block BACK-UP_BLK, the ECC component 138 may provide the test read manager 904 with a second trigger signal SIG_TRIG2.

The test read manager 904 may increment the count value k in response to the second trigger signal SIG_TRIG2 provided from the ECC component 138. In accordance with an embodiment of the present invention, the test read manager 904 may increment the count value k whenever the memory device 150 reads the boot data by incrementing the count value k whenever the first trigger signal is provided or the second trigger signal SIG_TRIG2 is provided from the booting manager 902 as described above.

The ECC component 138 may detect and correct an error in the provided second boot data DATA_BOOT2. When the error in the second boot data DATA_BOOT2 is corrected, the ECC component 138 may process the boot data read operation on the back-up master block BACK-UP_BLK as having passed. When the ECC component 138 processes the boot data read operation on the back-up master block BACK-UP_BLK as having passed, the ECC component 138 may provide the booting manager 902 with the corrected second boot data DATA_BOOT2′. When the error in the second boot data DATA_BOOT2 is not corrected, the ECC component 138 may process the boot data read operation on the back-up master block BACK-UP_BLK as a failure. When the boot data read operation on the back-up master block BACK-UP_BLK is processed as a failure, the ECC component 138 may provide the booting manager 902 with the second failure signal SIG_FAIL2.

The booting manager 902 may perform a boot operation using the provided second boot data DATA_BOOT2′. The booting manager 902 may provide the test read manager 904 with a second completion signal SIG_COMPLETE2 after completing the boot operation. Also, the booting manager 902 may process the boot operation as a failure in response to the provided second failure signal SIG_FAIL2. According to an embodiment of the present invention, the test read manager 904 may control the memory device 150 to periodically perform a test read operation on the back-up master block BACK-UP_BLK. As a result, it is possible to prevent the boot data read operation on the back-up master block BACK-UP_BLK from being processed as a failure.

The test read manager 904 may compare the count value k with the threshold TH in response to the provided first completion is signal SIG_COMPLETE1 or the second completion signal

SIG_COMPLETE2. When the count value k reaches the threshold TH, the test read manager 904 may control the memory device 150 to perform a test read operation. The test read manager 904 may control the memory device 150 to perform a test read operation of reading the boot data stored in the back-up master block BACK-UP_BLK. The memory device 150 may provide the ECC component 138 with the third boot data DATA_BOOT3 that is read from the back-up master block BACK-UP_BLK according to the test read operation.

The ECC component 138 may detect and correct an error in the provided third boot data DATA_BOOT3. When the error in the third boot data DATA_BOOT3 is corrected, the ECC component 138 may provide the test read manager 904 with an initialization signal SIG_INITIATE. The test read manager 904 may initialize the counter value k to a value of ‘0’ in response to the provided initialization signal SIG INITIATE. When the error in the third boot data DATA_BOOT3 is not corrected, the ECC component 138 may provide the test read manager 904 with a third failure signal SIG_FAIL3.

The test read manager 904 may control the memory device 150 to perform a recovery operation on the back-up master block BACK-UP_BLK in response to the provided third failure signal SIG_FAIL3. The test read manager 904 may generate a new block for storing boot data DATA_BOOT in addition to the master block MASTER_BLK according to the recovery operation and use the generated new block as a back-up block for the master block MASTER_BLK, and process a deteriorated back-up master block BACK-UP_BLK as a bad block. For example, the test read manager 904 may allocate a new block and control the memory device 150 to copy the boot data BOOT_DATA in the master block MASTER_BLK into the allocated block of the memory device 150. The test read manager 904 may initialize the counter value k to ‘0’ after completing the recovery operation.

As described above, the test read manager 904 may increment the count value k whenever the first and second trigger signals SIG_TRIG1 and SIG_TRIG2 are provided from the ECC component 138. Also, the test read manager 904 may initialize the count value k to a value of ‘0’ when an initialization signal SIG_INITIATE is provided from the ECC component 138 or after the memory device 150 completes the recovery operation. The test read manager 904 may control the memory device 150 to perform a test read operation on the back-up master block BACK-UP_BLK whenever the count value k reaches the threshold value TH before initializing the count value k is initialized.

The back-up master block BACK-UP_BLK may be deteriorated due to charge loss while the memory device 150 repeatedly performs the operation of reading the boot data from the master block MASTER_BLK. According to an embodiment of the present invention, the test read manager 904 may periodically perform a test read operation on the back-up master block BACK-UP_BLK, and when the master block BACK-UP_BLK is deteriorated, control the memory device 150 to perform a recovery operation on the back-up master block BACK-UP_BLK. Therefore, when the operation of reading the boot data from the master block MASTER_BLK has failed and the boot data is read from the back-up master block BACK-UP_BLK, the integrity of the back-up master block BACK-UP_BLK is ensured.

For example, when the threshold value TH is 50, the test read manager 904 may control the memory device 150 to perform a test read operation of reading the boot data stored in the back-up master block BACK-UP_BLK whenever the memory device 150 performs the operation of reading the boot data from the master block MASTER_BLK or the back-up master block BACK-UP_BLK 50 times.

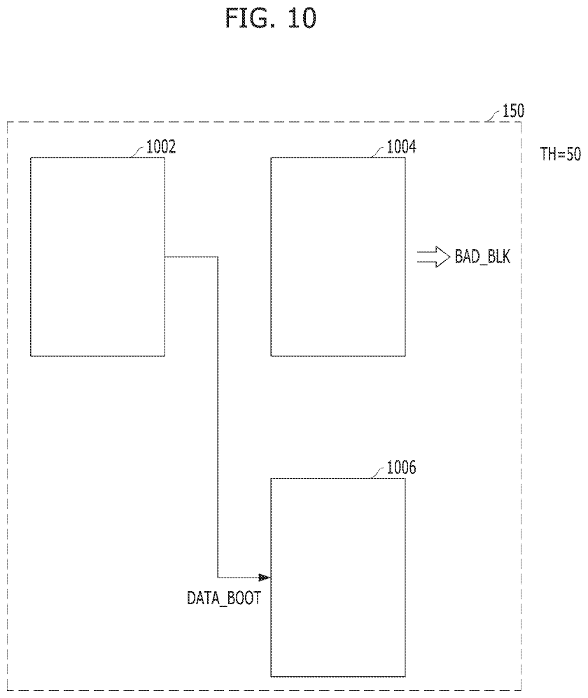

FIG. 10 is a block diagram illustrating a recovery operation in accordance with an embodiment of the present invention.

Referring to FIG. 10, when the number of error bits in the boot data that is read from the back-up master block 1004 is greater than or equal to a threshold, or when the boot data read from the back-up master block 1004 is an uncorrectable error (i.e., a UECC error), the test read manager 904 may process the back-up master block 1004 as a bad block BAD_BLK and allocate a new block 1006 as a back-up master block. The test read manager 904 may perform a recovery operation on the deteriorated back-up master block 1004 by copying the boot data DATA_BOOT in the master block 1002 into the newly designated back-up master block 1006. Therefore, when the boot instruction CMD_BOOT is provided from the host 102 later and the boot data read operation performed on the master block 1002 fails, the memory device 150 may prevent a boot operation failure because the memory device 150 may read the boot data from the back-up master block 1006 which is switched into a normal block through the recovery operation.

According to an embodiment of the present invention, the test read manager 904 may increment the count value k whenever the memory device 150 reads the boot data, and the test read manager 904 may control the test read operation of the memory device 150 whenever the count value k reaches the threshold TH. Therefore, at the moment of reading the boot data stored in the back-up master block BACK-UP_BLK after the operation of reading the boot data stored in the master block MASTER_BLK has failed, the back-up master block BACK-UP_BLK may prevent the boot operation from failing because the integrity may be ensured as a result of the test read operation.

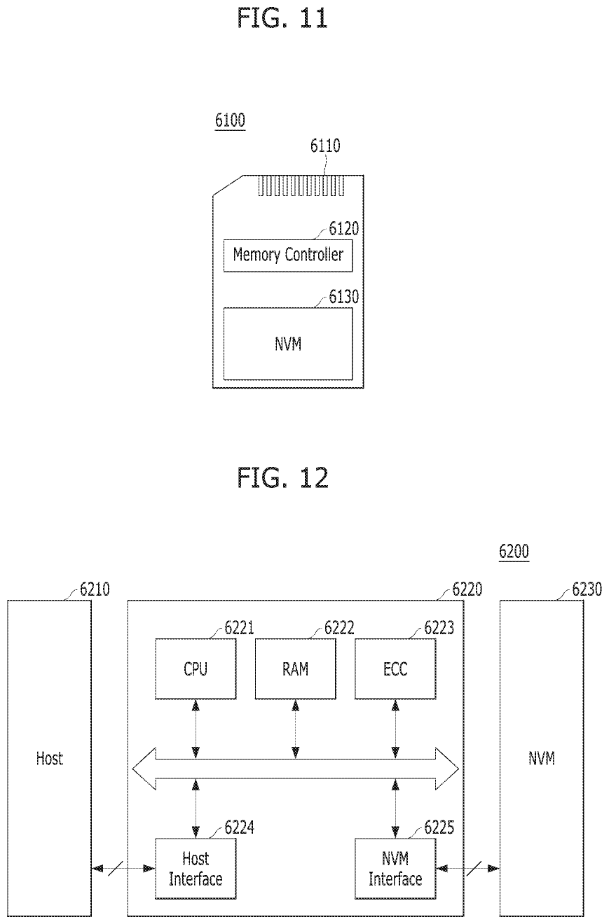

Referring to FIGS. 11 to 19, a data processing system and electronic devices, to which the above-described memory system 110 including the memory device 150 and the controller 130 is applied, are described in more detail in accordance with embodiments of the present invention.

FIG. 11 is a diagram schematically illustrating another example of the data processing system including the memory system in accordance with an embodiment. For example, FIG. 11 schematically illustrates a memory card system 6100 to which the memory system may be applied.

Referring to FIG. 11, the memory card system 6100 may include a memory controller 6120, a memory device 6130 and a connector 6110.

More specifically, the memory controller 6120 may be electrically connected to, and configured to access, the memory device 6130 embodied by a nonvolatile memory (NVM). For example, the memory controller 6120 may be configured to control read, write, erase and background operations of the memory device 6130. The memory controller 6120 may be configured to provide an interface between the memory device 6130 and a host, and to use firmware for controlling the memory device 6130. That is, the memory controller 6120 may correspond to the controller 130 of the memory system 110 described with reference to FIG. 1, and the memory device 6130 may correspond to the memory device 150 of the memory system 110 described with reference to FIG. 1.

Thus, the memory controller 6120 may include a random access memory (RAM), a processor, a host interface, a memory interface and an error correction component.

The memory controller 6120 may communicate with an external device, for example, the host 102 of FIG. 1 through the connector 6110. For example, as described with reference to FIG. 1, the memory controller 6120 may be configured to communicate with an external device through one or more of various communication protocols such as universal serial bus (USB), multimedia card (MMC), embedded MMC (eMMC), peripheral component interconnection (PCI), PCI express (PCIe), Advanced Technology Attachment (ATA), Serial-ATA, Parallel-ATA, small computer system interface (SCSI), enhanced small disk interface (EDSI), Integrated Drive Electronics (IDE), Firewire, universal flash storage (UFS), wireless fidelity (Wi-Fi or WiFi) and Bluetooth. Thus, the memory system and the data processing system may be applied to wired/wireless electronic devices, including mobile electronic devices.

The memory device 6130 may be implemented by a nonvolatile memory. For example, the memory device 6130 may be implemented by any of various nonvolatile memory devices such as an erasable and programmable ROM (EPROM), an electrically erasable and programmable ROM (EEPROM), a NAND flash memory, a NOR flash memory, a phase-change RAM (PRAM), a resistive RAM (ReRAM), a ferroelectric RAM (FRAM) and a spin torque transfer magnetic RAM (STT-RAM).

The memory controller 6120 and the memory device 6130 may be integrated into a single semiconductor device to form a solid-state drive (SSD). Also, the memory controller 6120 and the memory device 6130 may be so integrated to form a memory card such as a PC card (e.g., a personal computer memory card international association (PCMCIA) card), a compact flash (CF) card, a smart media card (e.g., a SM and a SMC), a memory stick, a multimedia card (e.g., a MMC, a RS-MMC, a MMCmicro and an eMMC), a secure digital (SD) card (e.g., a SD, a miniSD, a microSD and a SDHC), and/or a universal flash storage (UFS).

FIG. 12 is a diagram schematically illustrating another example of a data processing system 6200 including the memory system in accordance with an embodiment.

Referring to FIG. 12, the data processing system 6200 may include a memory device 6230 having one or more nonvolatile memories and a memory controller 6220 for controlling the memory device 6230. The data processing system 6200 illustrated in FIG. 12 may serve as a storage medium such as a memory card (CF, SD, micro-SD or the like) or USB device, as described with reference to FIG. 1. The memory device 6230 may correspond to the memory device 150 in the memory system 110 illustrated in FIG. 1, and the memory controller 6220 may correspond to the controller 130 in the memory system 110 illustrated in FIG. 1.

The memory controller 6220 may control a read, write or erase operation on the memory device 6230 in response to a request of the host 6210. The memory controller 6220 may include one or more central processing units (CPUs) 6221, a buffer memory such as a random access memory (RAM) 6222, an error correction code (ECC) circuit 6223, a host interface 6224 and a memory interface such as a nonvolatile memory (NVM) interface 6225.

The CPU 6221 may control overall operations on the memory device 6230, for example, read, write, file system management and bad page management operations. The RAM 6222 may be operated according to control of the CPU 6221, and used as a work memory, buffer memory or cache memory. When the RAM 6222 is used as a work memory, data processed by the CPU 6221 may be temporarily stored in the RAM 6222. When the RAM 6222 is used as a buffer memory, the RAM 6222 may be used for buffering data transmitted to the memory device 6230 from the host 6210 or vice versa. When the RAM 6222 is used as a cache memory, the RAM 6222 may assist the low-speed memory device 6230 to operate at high speed.

The ECC circuit 6223 may generate an error correction code (ECC) for correcting a failed bit or error bit of data provided from the memory device 6230. The ECC circuit 6223 may perform error correction encoding on data provided to the memory device 6230, thereby forming data with a parity bit. The parity bit may be stored in the memory device 6230. The ECC circuit 6223 may perform error correction decoding on data outputted from the memory device 6230. The ECC circuit 6223 may correct an error using the parity bit. For example, as described with reference to FIG. 1, the ECC circuit 6223 may correct an error using the low density parity check (LDPC) code, Bose-Chaudhri-Hocquenghem (BCH) code, turbo code, Reed-Solomon is (RS) code, convolution code, recursive systematic code (RSC) or coded modulation such as trellis coded modulation (TCM) or block coded modulation (BCM).

The memory controller 6220 may exchange data with the host 6210 through the host interface 6224. The memory controller 6220 may exchange data with the memory device 6230 through the NVM interface 6225. The host interface 6224 may be connected to the host 6210 through a parallel advanced technology attachment (PATA) bus, a serial advanced technology attachment (SATA) bus, a small computer system interface (SCSI), a universal serial bus (USB), a peripheral component interconnect-express (PCIe) or a NAND interface. The memory controller 6220 may have a wireless communication function with a mobile communication protocol such as wireless fidelity (WiFi) or long term evolution (LTE). The memory controller 6220 may be connected to an external device, for example, the host 6210 or another external device, and then exchange data with the external device. In particular, as the memory controller 6220 is configured to communicate with the external device according to one or more of various communication protocols, the memory system and the data processing system may be applied to wired/wireless electronic devices, particularly mobile electronic devices.

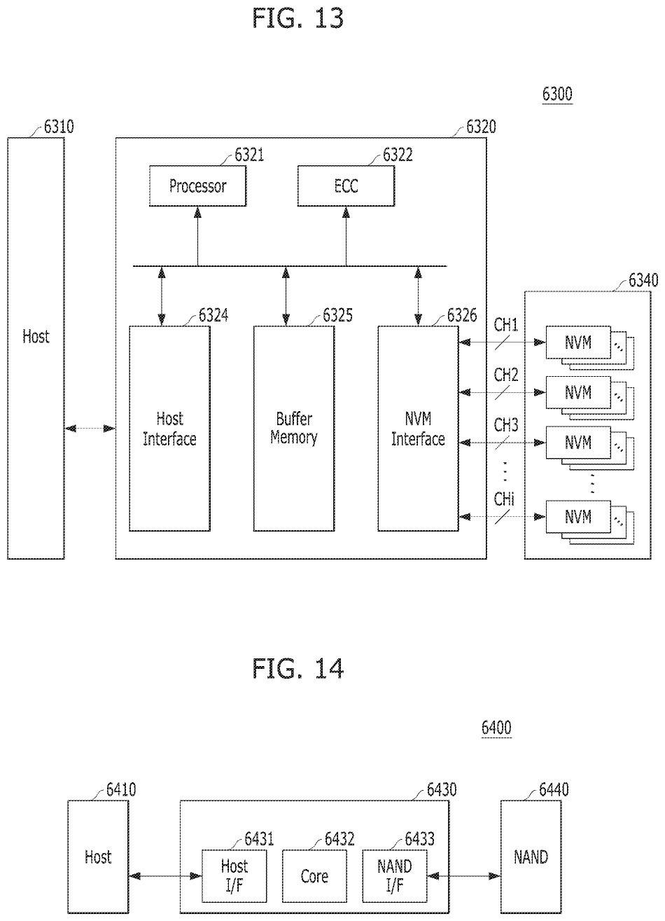

FIG. 13 is a diagram schematically illustrating another example of the data processing system including the memory system in accordance with an embodiment. For example, FIG. 13 schematically illustrates a solid state drive (SSD) 6300 to which the memory system may be applied.

Referring to FIG. 13, the SSD 6300 may include a controller 6320 and a memory device 6340 including a plurality of nonvolatile memories. The controller 6320 may correspond to the controller 130 in the memory system 110 of FIG. 1, and the memory device 6340 may correspond to the memory device 150 in the memory system of FIG. 1.

More specifically, the controller 6320 may be connected to the memory device 6340 through a plurality of channels CH1 to CHi. The controller 6320 may include one or more processors 6321, a buffer memory 6325, an error correction code (ECC) circuit 6322, a host interface 6324 and a memory interface, for example, a nonvolatile memory interface 6326.

The buffer memory 6325 may temporarily store data provided from the host 6310 or data provided from a plurality of flash memories NVM included in the memory device 6340. Further, the buffer memory 6325 may temporarily store meta data of the plurality of flash memories NVM, for example, map data including a mapping table. The buffer memory 6325 may be embodied by any of a variety of volatile memories such as a dynamic random access memory (DRAM), a synchronous DRAM (SDRAM), a double data rate (DDR) SDRAM, a low power DDR (LPDDR) SDRAM and a graphics RAM (GRAM) or nonvolatile memories such as a ferroelectric RAM (FRAM), a resistive RAM (RRAM or ReRAM), a spin-transfer torque magnetic RAM (STT-MRAM) and a phase-change RAM (PRAM). FIG. 13 illustrates that the buffer memory 6325 is embodied in the controller 6320. However, the buffer memory 6325 may be external to the controller 6320.

The ECC circuit 6322 may calculate an error correction code (ECC) value of data to be programmed to the memory device 6340 during a program operation, perform an error correction operation on data read from the memory device 6340 based on the ECC value during a read operation, and perform an error correction operation on data recovered from the memory device 6340 during a failed data recovery operation.

The host interface 6324 may provide an interface function with an external device, for example, the host 6310, and the nonvolatile memory interface 6326 may provide an interface function with the memory device 6340 connected through the plurality of channels.

Furthermore, a plurality of SSDs 6300 to which the memory system 110 of FIG. 1 may be applied may be provided to embody a data processing system, for example, a redundant array of independent disks (RAID) system. The RAID system may include the plurality of SSDs 6300 and a RAID controller for controlling the plurality of SSDs 6300. When the RAID controller performs a program operation in response to a write command provided from the host 6310, the RAID controller may select one or more memory systems or SSDs 6300 according to a plurality of RAID levels, that is, RAID level information of the write command provided from the host 6310 in the SSDs 6300, and output data corresponding to the write command to the selected SSDs 6300. Furthermore, when the RAID controller performs a read command in response to a read command provided from the host 6310, the RAID controller may select one or more memory systems or SSDs 6300 according to a plurality of RAID levels, that is, RAID level information of the read command provided from the host 6310 in the SSDs 6300, and provide data read from the selected SSDs 6300 to the host 6310.

FIG. 14 is a diagram schematically illustrating another example of the data processing system including the memory system in accordance with an embodiment. For example, FIG. 14 schematically illustrates an embedded Multi-Media Card (eMMC) 6400 to which the memory system may be applied.

Referring to FIG. 14, the eMMC 6400 may include a controller 6430 and a memory device 6440 embodied by one or more NAND flash memories. The controller 6430 may correspond to the controller 130 in the memory system 110 of FIG. 1. The memory device 6440 may correspond to the memory device 150 in the memory system 110 of FIG. 1.

More specifically, the controller 6430 may be connected to the memory device 6440 through a plurality of channels. The controller 6430 may include one or more cores 6432, a host interface 6431 and a memory interface, for example, a NAND interface 6433.

The core 6432 may control overall operations of the eMMC 6400, the host interface 6431 may provide an interface function between the controller 6430 and the host 6410, and the NAND interface 6433 may provide an interface function between the memory device 6440 and the controller 6430. For example, the host interface 6431 may serve as a parallel interface, for example, MMC interface as described with reference to FIG. 1. Furthermore, the host interface 6431 may serve as a serial interface, for example, ultra high speed (UHS)-I/UHS-II interface.

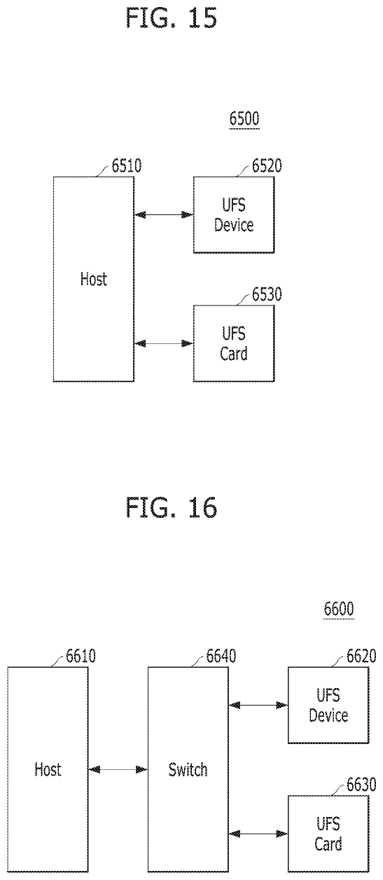

FIGS. 15 to 18 are diagrams schematically illustrating other examples of the data processing system including the memory system in accordance with embodiments. For example, FIGS. 15 to 18 schematically illustrate universal flash storage (UFS) systems to which the memory system may be applied.

Referring to FIGS. 15 to 18, the UFS systems 6500, 6600, 6700, 6800 may include hosts 6510, 6610, 6710, 6810, UFS devices 6520, 6620, 6720, 6820 and UFS cards 6530, 6630, 6730, 6830, respectively. The hosts 6510, 6610, 6710, 6810 may serve as application processors of wired/wireless electronic devices or particularly mobile electronic devices, the UFS devices 6520, 6620, 6720, 6820 may serve as embedded UFS devices, and the UFS cards 6530, 6630, 6730, 6830 may serve as external embedded UFS devices or removable UFS cards.

The hosts 6510, 6610, 6710, 6810, the UFS devices 6520, 6620, 6720, 6820 and the UFS cards 6530, 6630, 6730, 6830 in the respective UFS systems 6500, 6600, 6700, 6800 may communicate with external devices, for example, wired/wireless electronic devices or particularly mobile electronic devices through UFS protocols, and the UFS devices 6520, 6620, 6720, 6820 and the UFS cards 6530, 6630, 6730, 6830 may be embodied by the memory system 110 illustrated in FIG. 1. For example, in the UFS systems 6500, 6600, 6700, 6800, the UFS devices 6520, 6620, 6720, 6820 may be embodied in the form of the data processing system 6200, the SSD 6300 or the eMMC 6400 described with reference to FIGS. 12 to 14, and the UFS cards 6530, 6630, 6730, 6830 may be embodied in the form of the memory card system 6100 described with reference to FIG. 11.

Furthermore, in the UFS systems 6500, 6600, 6700, 6800, the hosts 6510, 6610, 6710, 6810, the UFS devices 6520, 6620, 6720, 6820 and the UFS cards 6530, 6630, 6730, 6830 may communicate with each other through an UFS interface, for example, MIPI M-PHY and MIPI UniPro (Unified Protocol) in MIPI (Mobile Industry Processor Interface). Furthermore, the UFS devices 6520, 6620, 6720, 6820 and the UFS cards 6530, 6630, 6730, 6830 may communicate with each other through any of various protocols other than the UFS protocol, for example, universal storage bus (USB) Flash Drives (UFDs), a multi-media card (MMC), a secure digital (SD), a mini-SD, and a micro-SD.

In the UFS system 6500 illustrated in FIG. 15, each of the host 6510, the UFS device 6520 and the UFS card 6530 may include UniPro. The host 6510 may perform a switching operation to communicate with the UFS device 6520 and the UFS card 6530. In particular, the host 6510 may communicate with the UFS device 6520 or the UFS card 6530 through link layer switching, for example, L3 switching at the UniPro. The UFS device 6520 and the UFS card 6530 may communicate with each other through link layer switching at the UniPro of the host 6510. In the illustrated embodiment, one UFS device 6520 and one UFS card 6530 are connected to the host 6510. However, a plurality of UFS devices and UFS cards may be connected in parallel or in the form of a star to the host 6410. A star formation is an arrangement in which a single device is coupled with plural devices for centralized operation. A plurality of UFS cards may be connected in parallel or in the form of a star to the UFS device 6520 or connected in series or in the form of a chain to the UFS device 6520.

In the UFS system 6600 illustrated in FIG. 16, each of the host 6610, the UFS device 6620 and the UFS card 6630 may include UniPro. The host 6610 may communicate with the UFS device 6620 or the UFS card 6630 through a switching module 6640 performing a switching operation, for example, through the switching module 6640 which performs link layer switching at the UniPro, for example, L3 switching. The UFS device 6620 and the UFS card 6630 may communicate with each other through link layer switching of the switching module 6640 at UniPro. In the illustrated embodiment, one UFS device 6620 and one UFS card 6630 are connected to the switching module 6640. However, a plurality of UFS devices and UFS cards may be connected in parallel or in the form of a star to the switching module 6640. A plurality of UFS cards may be connected in series or in the form of a chain to the UFS device 6620.

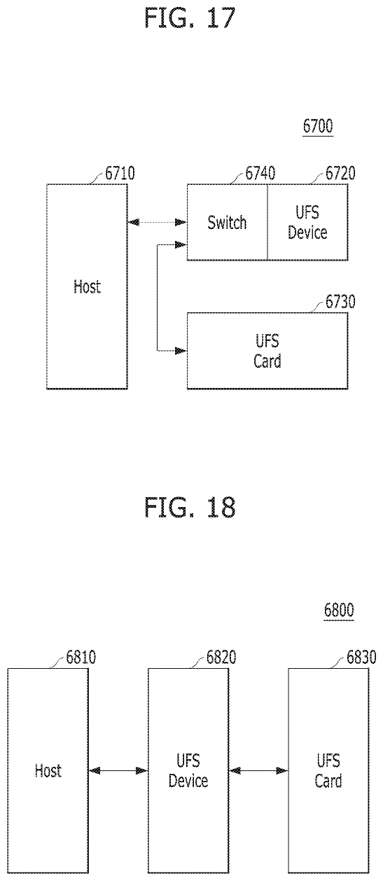

In the UFS system 6700 illustrated in FIG. 17, each of the host 6710, the UFS device 6720 and the UFS card 6730 may include UniPro. The host 6710 may communicate with the UFS device 6720 or the UFS card 6730 through a switching module 6740 performing a switching operation, for example, through the switching module 6740 which performs link layer switching at the UniPro, for example, L3 switching. The UFS device 6720 and the UFS card 6730 may communicate with each other through link layer switching of the switching module 6740 at the UniPro. The switching module 6740 may be integrated as one module with the UFS device 6720 inside or outside the UFS device 6720. In the illustrated embodiment, one UFS device 6720 and one UFS card 6730 are connected to the switching module 6740. However, a plurality of modules, each including the switching module 6740 and the UFS device 6720, may be connected in parallel or in the form of a star to the host 6710. In another example, a plurality of modules may be connected in series or in the form of a chain to each other. Furthermore, a plurality of UFS cards may be connected in parallel or in the form of a star to the UFS device 6720.

In the UFS system 6800 illustrated in FIG. 18, each of the host 6810, the UFS device 6820 and the UFS card 6830 may include M-PHY and UniPro. The UFS device 6820 may perform a switching operation to communicate with the host 6810 and the UFS card 6830. In particular, the UFS device 6820 may communicate with the host 6810 or the UFS card 6830 through a switching operation between the M-PHY and UniPro module for communication with the host 6810 and the M-PHY and UniPro module for communication with the UFS card 6830, for example, through a target identifier (ID) switching operation. The host 6810 and the UFS card 6830 may communicate with each other through target ID switching between the M-PHY and UniPro modules of the UFS device 6820. In the illustrated embodiment, one UFS device 6820 is connected to the host 6810 and one UFS card 6830 is connected to the UFS device 6820. However, a plurality of UFS devices may be connected in parallel or in the form of a star to the host 6810, or connected in series or in the form of a chain to the host 6810. A plurality of UFS cards may be connected in parallel or in the form of a star to the UFS device 6820, or connected in series or in the form of a chain to the UFS device 6820.

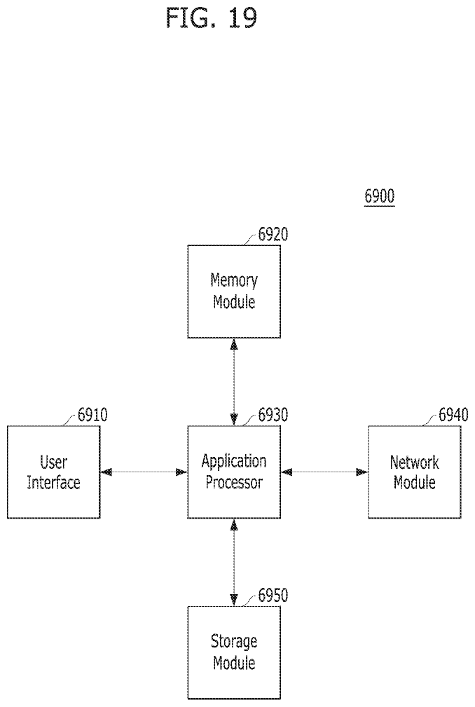

FIG. 19 is a diagram schematically illustrating another example of the data processing system including the memory system in accordance with an embodiment of the present invention. For example, FIG. 19 is a diagram schematically illustrating a user system 6900 to which the memory system may be applied.

Referring to FIG. 19, the user system 6900 may include an application processor 6930, a memory module 6920, a network module 6940, a storage module 6950 and a user interface 6910.

More specifically, the application processor 6930 may drive components in the user system 6900, for example, an OS, and include controllers, interfaces and a graphic engine which control the components included in the user system 6900. The application processor 6930 may be provided as System-on-Chip (SoC).

The memory module 6920 may be used as a main memory, work memory, buffer memory or cache memory of the user system 6900. The memory module 6920 may include a volatile random access memory (RAM) such as a dynamic RAM (DRAM), a synchronous DRAM (SDRAM), a double data rate (DDR) SDRAM, a DDR2 SDRAM, a DDR3 SDRAM, a low power DDR (LPDDR) SDARM, a LPDDR3 SDRAM or a LPDDR4 SDRAM or a nonvolatile RAM such as a phase-change RAM (PRAM), a resistive RAM (ReRAM), a magneto-resistive RAM (MRAM) or a ferroelectric RAM (FRAM). For example, the application processor 6930 and the memory module 6920 may be packaged and mounted, based on package on package (PoP).

The network module 6940 may communicate with external devices. For example, the network module 6940 may not only support wired communication, but also support various wireless communication protocols such as code division multiple access (CDMA), global system for mobile communication (GSM), wideband CDMA (WCDMA), CDMA-2000, time division multiple access (TDMA), long term evolution (LTE), worldwide interoperability for microwave access (WiMAX), wireless local area network (WLAN), ultra-wideband (UWB), Bluetooth, wireless display (WI-DI), thereby communicating with wired/wireless electronic devices, particularly mobile electronic devices. Therefore, the memory system and the data processing system, in accordance with an embodiment of the present invention, can be applied to wired/wireless electronic devices. The network module 6940 may be included in the application processor 6930.

The storage module 6950 may store data, for example, data received from the application processor 6930, and then may transmit the stored data to the application processor 6930. The storage module 6950 may be embodied by a nonvolatile semiconductor memory device such as a phase-change RAM (PRAM), a magnetic RAM (MRAM), a resistive RAM (ReRAM), a NAND flash, a NOR flash and a 3D NAND flash, and provided as a removable storage medium such as a memory card or external drive of the user system 6900. The storage module 6950 may correspond to the memory system 110 described with reference to FIG. 1. Furthermore, the storage module 6950 may be embodied as an SSD, an eMMC and an UFS as described above with reference to FIGS. 13 to 18.

The user interface 6910 may include interfaces for inputting data or commands to the application processor 6930 or outputting data to an external device. For example, the user interface 6910 may include user input interfaces such as a keyboard, a keypad, a button, a touch panel, a touch screen, a touch pad, a touch ball, a camera, a microphone, a gyroscope sensor, a vibration sensor and a piezoelectric element, and user output interfaces such as a liquid crystal display (LCD), an organic light emitting diode (OLED) display device, an active matrix OLED (AMOLED) display device, an LED, a speaker and a motor.

Furthermore, when the memory system 110 of FIG. 1 is applied to a mobile electronic device of the user system 6900, the application processor 6930 may control overall operations of the mobile electronic device, and the network module 6940 may serve as a communication module for controlling wired/wireless communication with an external device. The user interface 6910 may display data processed by the processor 6930 on a display/touch module of the mobile electronic device, or support a function of receiving data from the touch panel.

According to embodiments of the present invention, the memory system may prevent a boot operation from failing by performing a test read operation on a back-up master block whenever the number of times boot data is read reaches a threshold value.

While the present invention has been illustrated and described with respect to the specific embodiments, it will be apparent to those skilled in the art in light of the present disclosure that various changes and modifications may be made without departing from the spirit and scope of the invention as defined in the following claims.

What is claimed is:

1. A memory system, comprising:
a memory device including a master block and a back-up master block; and
a controller suitable for performing a boot operation by using boot data that is read from the master block or the back-up master block,
wherein the controller comprises:
a booting manager suitable for reading boot data from the back-up master block when an operation of reading the boot data from the master block failed; and
a test read manager suitable for:
performing a test read operation on the back-up master block whenever the number of times that the boot data is read reaches a threshold, and
performing a recovery operation on the back-up master block when the test read operation fails.

2. The memory system of claim 1, wherein the controller further includes:
an error correction code (ECC) component suitable for correcting an error in the boot data that is read from the master block or the back-up master block.

3. The memory system of claim 1, wherein the controller further includes:
a memory suitable for storing information about the number of times that the boot data is read.

4. The memory system of claim 2, wherein the ECC component processes an operation of reading the boot data as a failure when the number of error bits in the read boot data is greater than or equal to a threshold value.

5. The memory system of claim 1, wherein the recovery operation includes an operation of processing the back-up master block as a bad block and storing back-up data for the master block into a new block, when a test read operation for the back-up master block fails.

6. The memory system of claim 1, wherein the test read manager initializes the number of times that the boot data is read after the recovery operation is performed or after the test read operation passes.

7. The memory system of claim 1, wherein the boot data includes at least one of a boot loader and firmware that drives the boot operation.

8. The memory system of claim 1, wherein the back-up master block stores back-up data for the boot data stored in the master block. cm 9. The memory system of claim 1, wherein the test read manager increments the number of times that the boot data is read each time the booting manager reads the boot data.

10. The memory system of claim 3, wherein the memory includes a volatile memory.

11. A method for operating a memory system, comprising:
performing a boot operation by using boot data that is read from a master block or a back-up master block of a memory device,
wherein the performing of the boot operation comprises:
reading boot data from the back-up master block when an operation of reading the boot data from a master block failed; and
performing a test read operation on the back-up master block whenever the number of times that the boot data is read reaches a threshold; and
performing a recovery operation on the back-up master block when the test read operation fails.

12. The method of claim 11, further comprising:
correcting an error in the boot data that is read from the master block or the back-up master block.

13. The method of claim 11, further comprising:
storing information about the number of times that the boot data is read in a memory.

14. The method of claim 12, wherein the correcting of the error in the boot data that is read from the master block or the back-up master block includes
processing an operation of reading the boot data as a failure when the number of error bits in the read boot data is greater than or equal to a threshold value.

15. The method of claim 11, wherein the performing of the recovery operation on the back-up master block includes
processing the back-up master block as a bad block and storing back-up data for the master block into a new block, when a test read operation for the back-up master block fails.

16. The method of claim 11, wherein the performing of the test read operation on the back-up master block whenever the number of times that the boot data is read reaches the threshold includes
initializing the number of times that the boot data is read after the recovery operation is performed or after the test read operation passes.

17. The method of claim 11, wherein the boot data includes at least one of a boot loader and firmware that drives the boot operation.

18. The method of claim 11, wherein the back-up master block stores back-up data for the boot data stored in the master block.

19. The method of claim 11, wherein the performing of the recovery operation on the back-up master block when the test read operation is failed includes
incrementing the number of times that the boot data is read each time the boot data is read.

20. The method of claim 13, wherein the memory includes a volatile memory.
